(19) United States
(12) Patent Application Publication
(10) Pub. No.: US 2025/0294454 A1
(43) Pub. Date: Sep. 18, 2025

(54) SYSTEM AND APPARATUS SUITABLE FOR FACILITATING ENERGY EFFICIENCY AND A PROCESSING/COMMUNICATION METHOD IN ASSOCIATION THERETO

(71) Applicant: Continental Automotive Technologies GmbH, Hannover (DE)

(72) Inventors: Rikin Shah, Langen (DE); Hojin Kim, Regensburg (DE); David Gonzalez Gonzalez, Egelsbach (DE)

(73) Assignee: Continental Automotive Technologies GmbH, Hannover (DE)

(21) Appl. No.: 18/861,226

(22) PCT Filed: Apr. 20, 2023
(86) PCT No.: PCT/EP2023/060369

§ 371 Date: Oct. 29, 2024

(30) Foreign Application Priority Data
Apr. 29, 2022 (DE) 10 2022 204 247.6

(51) Int. Cl. H04W 52/02; H04W 76/28

(52) U.S. Cl. CPC H04W 52/0229; H04W 52/0258; H04W 76/28

(57) ABSTRACT

An apparatus is capable of receiving at least one input signal indicative of at least one device status. The apparatus can include a receiver and a processor. The receiver can be configured to receive the at least one input signal, and the processor can be configured to perform at least one processing task in association with adaptive control-based processing in a manner so as to adaptively control operational configuration associated with the apparatus based on the at least one input signal. Operational configuration associated with the apparatus can be associated with at least one wake-up period, and operational configuration associated with the apparatus can be capable of being adaptively controlled by skipping at least one wake-up period and/or extending at least one wake-up period.

### CROSS-REFERENCE TO RELATED APPLICATIONS

The present application is a National Stage Application under 35 U.S.C. § 371 of International Patent Application No. PCT/EP2023/060369 filed on Apr. 20, 2023, and claims priority from German Patent Application No. 10 2022 204 247.6 filed on Apr. 29, 2022, in the German Patent and Trademark Office, the disclosures of which are herein incorporated by reference in their entireties.

### TECHNICAL FIELD

The present disclosure generally relates to one or both of a system and an apparatus suitable for facilitating energy efficiency and/or communication efficiency in association with, for example, a User Equipment (UE) usable for communication. The present disclosure further relates a processing/communication method which can be associated with the system and/or the apparatus.

### BACKGROUND

Generally, energy efficiency would be helpful/desired in communication networks. An example of a communication network would be a 3rd Generation Partnership Project (3GPP) 5G (fifth generation) New Radio (NR) standard-based telecommunications network.

Typically, techniques such as a Discontinuous Reception (DRX) mechanism and communication of Wake-Up Signals (WUS) can be utilized to assist in facilitating energy efficiency.

The present disclosure contemplates that conventional techniques (e.g., DRX and/or WUS) may not facilitate efficiency in an optimal manner.

The present disclosure contemplates that it would be helpful to address (or at least mitigate) one or more issues in relation to conventional techniques for facilitating efficiency.

### BRIEF SUMMARY

In accordance with an aspect of the disclosure, there is provided an apparatus which operational configuration can, for example, be adaptively controlled (e.g., regulated/tweaked), in accordance with an embodiment of the disclosure. Moreover, the apparatus (e.g., a User Equipment) can, for example, be communicable with at least one device (e.g., which can be associated with/correspond to at least one Next Generation Node B), in accordance with an embodiment of the disclosure.

The apparatus can, for example, be configured to receive (e.g., capable of receiving) one or more input signals which can be indicative of status associated with at least one device (i.e., device status), in accordance with an embodiment of the disclosure.

In one embodiment, the apparatus can, for example, include a receiver (e.g., a first module) and a processor (e.g., a second module). The receiver can, for example, be coupled to the processor.

The receiver can, for example, be configured to receive the input signal(s), in accordance with an embodiment of the disclosure.

The processor can, for example, be configured to perform at least one processing task in association with adaptive control-based processing in a manner so as to adaptively control operational configuration associated with the apparatus, in accordance with an embodiment of the disclosure. Operational configuration associated with the apparatus can, for example, be adaptively controlled based on the input signal(s). Moreover, operational configuration associated with the apparatus can, for example, be associated with at least one wake-up period (e.g., time-based period).

In one embodiment, operational configuration associated with the apparatus can be capable of being adaptively controlled by manner of one or both of skipping at least one wake-up period and extending at least one wake-up period. In this regard, it is appreciable that operational configuration associated with the apparatus can be capable of being adaptively controlled by manner of skipping at least one wake-up period and/or extending at least one wake-up period (i.e., at least one of skipping at least one wake-up period and extending at least one wake-up period).

In one embodiment, the input signal(s) can be indicative of a device status (i.e., status associated with the device) being associated with at least one deactivated period. Moreover, operational configuration associated with the apparatus can be capable of being adaptively controlled by manner of skipping at least one wake-up period when:
the least one wake-up period coincides with the deactivated period, and
the at least one wake-up period is shorter than the deactivated period.

In one embodiment, the input signal(s) can be indicative of a device status (i.e., status associated with the device) being associated with at least one deactivated period. Moreover, operational configuration associated with the apparatus can be capable of being adaptively controlled by manner of extending at least one wake-up period when:
the at least one wake-up period coincides with the deactivated period, and.
the at least one wake-up period is longer than the deactivated period.

Moreover, in one embodiment, adaptive control-based processing can, for example, be based on any one of, or any combination of, the following:
determination-based processing,
comparison-based processing, and
instruction generating-based processing.

Specifically, adaptive control-based processing can be based on determination-based processing, comparison-based processing and/or instruction generating-based processing (i.e., at least one of determination-based processing, comparison-based processing and instruction generating-based processing), in accordance with an embodiment of the disclosure.

In one embodiment, determination-based processing can, for example be associated with determining whether the least one wake-up period coincides with the deactivated period.

Additionally, in one embodiment, comparison-based processing can, for example, be associated with comparing the at least one wake-up period and the deactivated period in a manner so as to determine whether the at least one wake-up period is shorter than the deactivated period. In another embodiment, the comparison-based processing can, for example, be associated with comparing the deactivated period and the at least one wake-up period in a manner so as to determine whether the at least one wake-up period is longer than the deactivated period.

Furthermore, in one embodiment, instruction generating-based processing can, for example, be associated with generating one or more output signals in association with adaptive control of the operational configuration by manner of skipping at least one wake-up period. In another embodiment, instruction generating-based processing can, for example, be associated with generating one or more output signals in association with adaptive control of the operational configuration by manner of extending at least one wake-up period.

The present disclosure contemplates that by manner of, for example, adaptive control (e.g., regulating/tweaking) by manner of one or both of skipping at least one active period as appropriate and/or extending at least one active period as appropriate, efficiency (e.g., power/energy efficiency and/or communication efficiency) can possibly be facilitated, in accordance with an embodiment of the disclosure. For example, unnecessary consumption of power can possibly be reduced (or, preferably, eliminated) and/or unnecessary data access delay can possibly be reduced (or, preferably, eliminated), in accordance with an embodiment of the disclosure.

In accordance with an aspect of the disclosure, there is provided a communication/processing method (e.g., referable to as a processing method).

The processing method can, for example, include an input step and a processing step, in accordance with an embodiment of the disclosure. As an option, the processing method can, for example, include an output step, in accordance with an embodiment of the disclosure.

The input step can, for example, include receiving (e.g., by an apparatus) one or more input signals which can be indicative of status associated with at least one device, in accordance with an embodiment of the disclosure.

The processing step can, for example, include performing at least one processing task (e.g., by an apparatus) which can be associated with at least one adaptive control-based processing, in accordance with an embodiment of the disclosure. The processing task(s) associated with adaptive control-based processing can, for example, be performed based on the input signal(s), in accordance with an embodiment of the disclosure. Moreover, the processing task(s) associated with adaptive control-based processing can, for example, be performed in a manner so as to adaptively control operational configuration associated with at least one apparatus based on status associated with the device(s), in accordance with an embodiment of the disclosure.

In one embodiment, operational configuration associated with the apparatus can, for example be associated with at least one of a wake-up period. Moreover, the input signal(s) can be indicative of device status (e.g., status(es)/mode(s) associated with the device(s)) being associated with, for example, at least one deactivated period. Furthermore, operational configuration associated with the apparatus can be capable of being adaptively controlled by manner of, for example, skipping at least one wake-up period when:
the least one wake-up period coincides with the deactivated period, and.
the at least one wake-up period is shorter than the deactivated period.

In one embodiment, operational configuration associated with the apparatus can, for example be associated with at least one of a wake-up period. Moreover, the input signal(s) can be indicative of device status (e.g., status(es)/mode(s) associated with the device(s)) being associated with, for example, at least one deactivated period. Furthermore, operational configuration associated with the apparatus can be capable of being adaptively controlled by manner of, for example, extending at least one wake-up period when:
the least one wake-up period coincides with the deactivated period, and.
the at least one wake-up period is longer than the deactivated period.

The present disclosure contemplates that by manner of, for example, adaptive control (e.g., regulating/tweaking) by manner of one or both of skipping at least one active period as appropriate and/or extending at least one active period as appropriate, efficiency (e.g., power/energy efficiency and/or communication efficiency) can possibly be facilitated, in accordance with an embodiment of the disclosure. For example, unnecessary consumption of power can possibly be reduced (or, preferably, eliminated) and/or unnecessary data access delay can possibly be reduced (or, preferably, eliminated), in accordance with an embodiment of the disclosure.

The present disclosure further contemplates a computer program which can include instructions which, when the program is executed by a computer, cause the computer to carry out the input step, the processing step and/or the output step of the processing method. For example, the computer program can include instructions which, when the program is executed by a computer, cause the computer to carry out the input step and the processing step, in accordance with an embodiment of the disclosure.

The present disclosure yet further contemplates a computer readable storage medium having data stored therein representing software executable by a computer, the software including instructions, when executed by the computer, to carry out the input step, the processing step and/or the output step of the processing method. For example, the computer readable storage medium can have data stored therein representing software executable by a computer, the software including instructions, when executed by the computer, cause the computer to carry out the input step and the processing step, in accordance with an embodiment of the disclosure.

### BRIEF DESCRIPTION OF THE DRAWINGS

Embodiments of the disclosure are described hereinafter with reference to the following drawings.

FIG. 1 shows a system which can include at least one apparatus, according to an embodiment of the disclosure.

FIG. 2 shows the apparatus of FIG. 1 in further detail, according to an embodiment of the disclosure.

FIG. 3 shows a processing/communication method in association with the system of FIG. 1, according to an embodiment of the disclosure.

### DETAILED DESCRIPTION

The present disclosure generally contemplates the facilitation of, for example, network (e.g., in association with 3GPP TS 38.321 based standard/specification etc.) and/or user equipment (UE) efficiency (e.g., energy/power efficiency and/or communication efficiency), in accordance with an embodiment of the disclosure.

It is contemplated that a User Equipment (UE) would not be able to receive downlink (DL) data when a cell (e.g., a Next Generation Node B, gNB) is deactivated (e.g., a “switched off” period). In this regard, it is appreciable that a UE may possibly have to continuously monitor a PUCCH (Physical Uplink Control Channel) during the UE DRX active time (i.e., during the active reception period of the DRX mode associated with the UE), leading to possible increase in power consumption by the UE (e.g., UE inefficiency in the context of power consumption). Moreover, there could potentially be data access delay due to, for example, mismatch between DRX active time associated with a UE and cell turn off period (i.e., deactivated). For example, if a gNB is not able to communicate data to a UE via the PDCCH at the current DRX active time associated with the UE (e.g., DRX can refer to the time period during which it is possible for the UE to receive communicated data) due to cell turn off period, data may then be communicated (i.e., via the PDDCH) at the next UE DRX active time which may result in data access delay (e.g., network inefficiency in the context of data access delay).

The above-noted possibility of increase in power consumption (e.g., by a UE) and possibility of data access delay (e.g., due to time mismatch as between UE DRX active time and cell turn off period) may, for example, contribute to one or more undesirable inefficiencies. An increase in (unnecessary) power consumption can, for example, be associated with energy/power inefficiency and data access delay can, for example, be associated with communication inefficiency, in accordance with an embodiment of the disclosure.

It is contemplated that it can be helpful to consider the possibility of regulating/tweaking user equipment (UE) behavior in relation to cell (e.g., a Next Generation Node B, gNB) activation and/or deactivation period (e.g., based on time) to address (or at least mitigate) the inefficiency/inefficiencies as noted earlier (e.g., power/energy inefficiency and/or communication inefficiency). Specifically, the present disclosure contemplates that defining UE behavior (e.g., by manner of adaptive control) in the context of communication (e.g., during downlink (DL) data transmission) when a cell is deactivated (e.g., switched-off) can possibly be helpful/useful in facilitating efficiency (e.g., energy/power efficiency and/or communication efficiency). For example, the present disclosure contemplates the possibility that a UE can be configured (e.g., configured by manner of adaptive control) to skip at least one active period (e.g., time-based) and/or extend at least one active period (e.g., time-based) such that communication (e.g., DL transmission) can, for example, be capable of being managed with improved efficiency in terms of energy/power (e.g., reduced power consumption) and/or communication (e.g., reduced data access delay).

It is contemplated that UE behavior can be regulated/tweaked by manner skipping at least one active period and/or extending at least one active period based on cell activation and/or deactivation period in a manner so as to facilitate efficiency (e.g., power/energy efficiency and/or communication efficiency), in accordance with an embodiment of the disclosure. For example, unnecessary consumption of power can be reduced (or, preferably, eliminated) and/or unnecessary data access delay can be reduced (or, preferably, eliminated), in accordance with an embodiment of the disclosure.

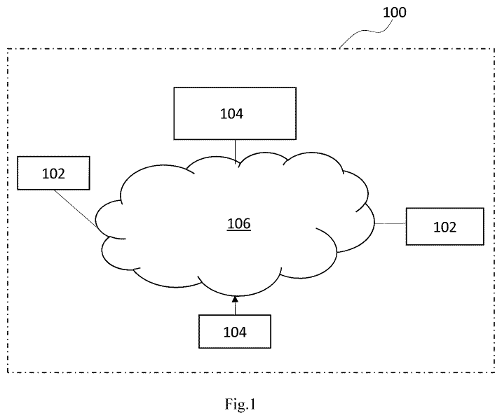

The foregoing will be discussed in further detail with reference to FIG. 1 to FIG. 3 hereinafter.

Referring to FIG. 1, a system 100 is shown, according to an embodiment of the disclosure. The system 100 can, for example, be suitable for one or both of facilitating energy/power efficiency and communication efficiency (i.e., energy/power efficiency and/or communication efficiency), in accordance with an embodiment of the disclosure.

As shown, the system 100 can include one or more apparatuses 102, at least one device 104 and, optionally, a communication network 106, in accordance with an embodiment of the disclosure.

The apparatus(es) 102 can be coupled to the device(s) 104. Specifically, the apparatus(es) 102 can, for example, be coupled to the device(s) 104 via the communication network 106, in accordance with an embodiment of the disclosure.

In one embodiment, the apparatus(es) 102 can be coupled to the communication network 106 and the device(s) 104 can be coupled to the communication network 106. Coupling can be by manner of one or both of wired coupling and wireless coupling. The apparatus(es) 102 can, in general, be configured to communicate with the device(s) 104 via the communication network 106, according to an embodiment of the disclosure.

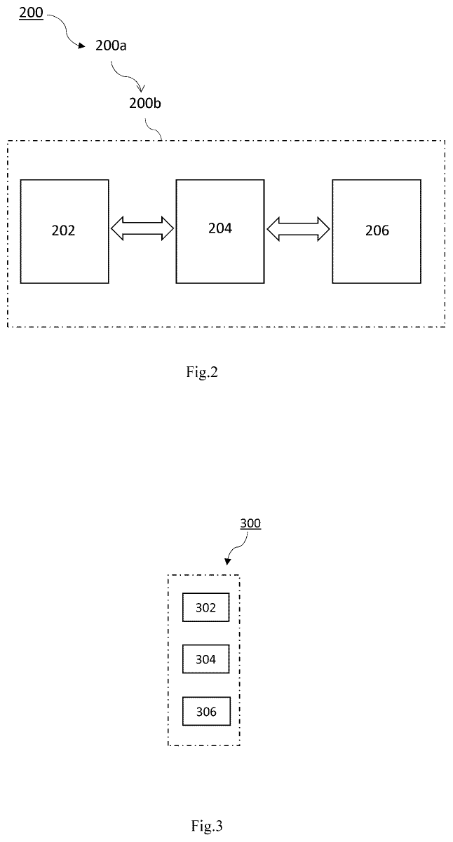

The apparatus(es) 102 can, for example, be associated with/correspond to/include one or more user equipment (UE) which can carry one or more computers, in accordance with an embodiment of the disclosure. For example, an apparatus 102 can correspond to a UE carrying at least one computer (e.g., an electronic device/module having computing capabilities such as an electronic mobile device which can be carried into a vehicle or an electronic module which can be installed in a vehicle, in accordance with an embodiment of the disclosure) which can be configured to perform one or more processing tasks in association with/which can include, for example, adaptive control-based processing, in accordance with an embodiment of the disclosure. In a more specific example, the apparatus(es) 102 can, in one embodiment, include one or more processors (not shown) which can be configured to perform one or more processing tasks in association with/which can include adaptive control-based processing, in accordance with an embodiment of the disclosure. In one embodiment, the apparatus(es) 102 can, for example, be configured to receive one or more input signals and perform at least one processing task (e.g., adaptive control-based processing) based on the input signal(s) in a manner so as to generate one or more output signals. The input signal(s) can, for example, be communicated from the device(s) 104 and received by the apparatus(es) 102, in accordance with an embodiment of the disclosure. As a possible option, the output signal(s) can, for example, be communicated from the apparatus(es) 102, in accordance with an embodiment of the disclosure. The apparatus(es) 102 will be discussed later in further detail with reference to FIG. 2, according to an embodiment of the disclosure.

The device(s) 104 can, for example, be associated with/correspond to at least one cell (e.g., at least one gNB). Moreover, the device(s) 104 can, for example, be configured to carry/be associated with/include one or more computers (e.g., an electronic device/module having computing capabilities) which can, for example, be configured to perform one or more processing tasks in association with the cell(s). The device(s) 104 can be configured to generate one or more input signals which can be communicated to the apparatus(es) 102, in accordance with an embodiment of the disclosure. This will be discussed later in further detail in the context of an example implementation, in accordance with an embodiment of the disclosure.

The communication network 106 can, for example, correspond to an Internet communication network, a cellular-based communication network, a wired-based communication network, a Global Navigation Satellite System (GNSS) based communication network, a wireless-based communication network, or any combination thereof. Communication (e.g., between the apparatuses 102 and/or between the apparatus(es) 102 and the device(s) 104) via the communication network 106 can be by manner of one or both of wired communication and wireless communication.

Earlier mentioned, the apparatus(es) 102 can, for example, be configured to receive at least one input signal and perform at least one processing task in association with adaptive control-based processing based on the input signal(s) in a manner so as to generate at least one output signal. Moreover, the device(s) 104 can, for example, be configured to generate (and communicate) the input signal(s) to the apparatus(es) 102, in accordance with an embodiment of the disclosure. This will be discussed, in accordance with an embodiment of the disclosure, in the context of an example implementation hereinafter.

In the example implementation, an apparatus 102 (referable to as a UE hereinafter in the context of this example implementation) can be carried in/by a vehicle. Moreover, a device 104 (referable to as a “gNB” hereinafter in the context of this example implementation) can be coupled to the UE (e.g., via the communication network 106).

The UE can, for example, configured to receive one or more input signal(s) communicable from the gNB. The input signal(s) can, for example, be indicative of gNB status, in accordance with an embodiment of the disclosure. A gNB status can, for example, include/be associated with/correspond to either an activated status (e.g., an activated mode) or a deactivated status (e.g., a deactivated mode). The activated status can, for example, be associated with an activated period which can, for example, be time-based. The deactivated status can, for example, be associated with a deactivated period which can, for example, be time-based. During activated status/mode, a gNB can, for example, be configured to communicate data (e.g., one or more data signals) via, for example, the PDCCH, in accordance with an embodiment of the disclosure. During the deactivated status/mode, a gNB can, for example, have limited communication capabilities and may not be capable of communicating data (e.g., in association with the deactivated status/mode, a gNB can be in power saving/down mode with limited or no data communication capability), in accordance with an embodiment of the disclosure.

The UE can, for example, be configured to determine/identify status/mode (e.g., “activated” or “deactivated”) associated with the gNB based on the input signal(s), in accordance with an embodiment of the disclosure.

In one example, based on at least one input signal, the UE can be configured to determine/identify that the gNB is in a “deactivated” status/mode for a time period (e.g., deactivated period can be 50 milliseconds, mS) from a reference point in time (e.g., a defined start point of 0 seconds, S), in accordance with an embodiment of the disclosure. In another example, based on at least one input signal, the UE can be configured to determine/identify that the gNB is in an “activated” status/mode for a time period (e.g., activated period can be 100 milliseconds, mS) from a reference point in time (e.g., immediately after the end of a preceding “deactivated” status/mode), in accordance with an embodiment of the disclosure. In yet another example, based on at least one input signal, the UE can be configured to determine/identify that the gNB is in a “deactivated” status/mode for a time period (e.g., deactivated period can be 75 milliseconds, mS) from a reference point in time (e.g., immediately after the end of a preceding “activated” status/mode), in accordance with an embodiment of the disclosure. In yet another further example, based on one or more input signals, the UE can be configured to determine/identify a plurality of status(es)/mode(s) in association with the gNB, in accordance with an embodiment of the disclosure. In a more specific example, in accordance with an embodiment of the disclosure, based on one or more input signals (e.g., one input signal), the UE can be configured to determine that the gNB is in a “deactivated” status/mode for a time period (e.g., deactivated period can be 25 mS) from a reference point in time (e.g., 0 S) and following the “deactivated” status/mode (e.g., after the deactivated period of 25 mS) the UE can be configured to determine that the gNB is in a “activated” status/mode for a time period (e.g., activated period can be 10 mS), and following the “activated” status/mode (e.g., after 35 mS from the 0 S reference point in time), UE can be configured to determine that the gNB is in a “deactivated” status/mode for a time period (e.g., deactivated period can be for another 15 mS after 35 mS from the 0 S reference point in time).

In the example implementation, the UE may be associated with one or more operational modes/configurations (e.g., one or more communication modes/configurations) and the UE can be configured in a manner such that, for example, the operational mode(s)/configuration(s) can be adapted based on the determined status(es)/mode(s) associated with the gNB, in accordance with an embodiment of the disclosure. In one example, the operational mode(s)/configuration(s) associated with the UE can be based on one or more communication modes in relation to DRX. In one embodiment, communication mode(s) in relation to DRX can, for example, include one or both of a “DRX active time” and a “DRX inactive time” (i.e., “DRX active time” and/or “DRX inactive time”). “DRX active time” can, for example, be in relation to a period (e.g., time-based period) in which the UE can be considered to be active and capable of receiving data from, for example, the gNB, in accordance with an embodiment of the disclosure. “DRX inactive time” can, for example, be in relation to a period (e.g., time-based period) in which the communication function(s) of the UE can be limited/restricted such that the UE can be considered to be inactive and receiving of data from, for example, the gNB can be impeded. During “DRX active time” the UE can, for example, be considered to be in “wake-up”/“active” mode, in accordance with an embodiment of the disclosure. During “DRX inactive time” the UE can, for example, be considered to be in “sleep” mode, in accordance with an embodiment of the disclosure. The “wake-up”/“active” mode can, for example, be associated with a wake-up period (or active period) which can, for example, be time-based. The “sleep” mode can, for example, be associated with a sleep period which can, for example, be time-based.

As mentioned, in the example implementation, the UE can be configured in a manner such that, for example, the operational mode(s)/configuration(s) associated with the UE can be adapted based on the determined status(es)/mode(s) associated with the gNB, in accordance with an embodiment of the disclosure. This will be discussed in further detail based on a first example scenario and a second example scenario hereinafter.

In the first example scenario, the UE can, for example, be configured to receive one or more input signals which can be indicative of the status(es)/mode(s) associated with the gNB. The UE can be configured to determine whether the “deactivated” status/mode period (i.e., deactivated period) associated with the gNB coincides (e.g., either a partial or a full overlap in the periods) with the “DRX active time” period (i.e., wake-up period), in accordance with an embodiment of the disclosure. In the event the “DRX active time” period coincides (i.e., at least partially) with the “deactivated” period, the UE can be configured to compare whether the “DRX active time” period is longer (or shorter) than the “deactivated” period, in accordance with an embodiment of the disclosure. If the “DRX active time” period coincides with the “deactivated” period and the “DRX active time” period is shorter than the “deactivated” period, the UE can be configured to go into “sleep” mode (i.e., the UE can be considered to be configured to skip the UE “active”/“Wake-up” period which is determined to be shorter than the coinciding gNB “deactivated” period), in accordance with an embodiment of the disclosure. Otherwise, if the “DRX active time” period coincides with the “deactivated” period and the “DRX active time” period is longer than the “deactivated” period, the UE can be configured to remain in “active”/“wake-up” mode, in accordance with an embodiment of the disclosure. In this regard, the UE can, for example, be configured to generate at least one output signal for commanding/instructing the UE to go into “sleep” mode, as appropriate, in accordance with an embodiment of the disclosure. Moreover, in this regard, it is appreciable that behavior associated with the UE (i.e., UE behavior) can be regulated/tweaked by manner skipping at least one active period. The present disclosure contemplates that doing so may be helpful in facilitating efficiency (e.g., power/energy efficiency and/or communication efficiency) as it can be deemed to be unnecessary for the UE to remain in “active”/“wake-up” mode when the gNB is in “deactivated” mode given that it is highly unlikely that the UE would be receiving data from the gNB. It is contemplated that reducing occurrence(s) of unnecessary “active”/wake-up” mode(s) can be helpful in, for example, reducing unnecessary power/energy consumption (e.g., by the UE) and/or reducing unnecessary monitoring of communication (e.g., unnecessary monitoring of DL data transmission which may not be forth coming).

In the second example scenario, the UE can, for example, be configured to receive one or more input signals which can be indicative of the status(es)/mode(s) associated with the gNB. The UE can be configured to determine whether the “deactivated” status/mode period (i.e., deactivated period) associated with the gNB coincides (e.g., either a partial or a full overlap in the periods) with the “DRX active time” period (i.e., wake-up period), in accordance with an embodiment of the disclosure. In the event the “DRX active time” period coincides (i.e., at least partially) with the “deactivated” period, the UE can be configured to compare whether the “DRX active time” period is longer (or shorter) than the “deactivated” period, in accordance with an embodiment of the disclosure. If the “DRX active time” period coincides with the “deactivated” period and the “DRX active time” period is longer than the “deactivated” period, the UE can be configured to extend the “DRX active time” period (i.e., the UE can be considered to be configured to extend/increase the UE “active”/“Wake-up” period which is determined to be longer than the coinciding gNB “deactivated” period), in accordance with an embodiment of the disclosure. Otherwise, if the “DRX active time” period coincides with the “deactivated” period and the “DRX active time” period is shorter than the “deactivated” period, the UE can be configured to go into “sleep” mode as discussed with reference to the first example scenario, in accordance with an embodiment of the disclosure. In this regard, the UE can, for example, be configured to generate at least one output signal for one or both of commanding/instructing the UE to extend/increase the “DRX active time” and commanding/instructing the UE to go into “sleep” mode, as appropriate, in accordance with an embodiment of the disclosure.

Additionally, in regard to the second example scenario, the present disclosure contemplates that the “DRX active time” (i.e., wake-up period) can, for example, be extended/increased by manner of configuring additional time through the network and/or restart the active time, in accordance with an embodiment of the disclosure. For example, it is contemplated that the UE can possibly be configured to extend/increase a wake-up period based on Medium Access Control (MAC) Control Element (CE) by manner of communicating (e.g., from the gNB) at least one MAC CE signal before the (current) wake up period is set to expire, in accordance with an embodiment of the disclosure. Furthermore, the MAC CE signal(s) can be capable of indicating amount of extension required/desired (e.g., time period for UE to extend wake up period), in accordance with an embodiment of the disclosure.

Moreover, in regard to the second example scenario, it is appreciable that behavior associated with the UE (i.e., UE behavior) can be regulated/tweaked by manner extending/increasing at least one active period (i.e., wake-up period). The present disclosure contemplates that doing so may be helpful in facilitating efficiency (e.g., power/energy efficiency and/or communication efficiency) as it may be helpful for the UE to remain in “active”/“wake-up” mode in an optimal manner (i.e., when the gNB is in “activated” mode). It is contemplated that by extending/increasing “active”/“wake-up” mode when gNB is in “activated” mode, UE operation can be optimal in that, for example, power/energy can suitably be consumed (e.g., by the UE) when DL data transmission can be considered to be most likely and/or unnecessary data access delay can be reduced as the UE can be “active”/“wake-up” mode so as to be able to receive DL data transmission from the gNB when the gNB is more/most likely to be communicating the data signal(s).

In the above manner, it is appreciable that the UE can be configured to perform at least one processing task which can include any one of, or any combination of, the following:
Receiving-based processing (e.g., in association with receiving the input signal(s), in accordance with an embodiment of the disclosure)
Determination-based processing (e.g., in association with determining whether the “deactivated” status/mode period associated with the gNB coincides with the “DRX active time” period, in accordance with an embodiment of the disclosure.
Comparison-based processing (e.g., in association with comparing whether the “DRX active time” period is longer/shorter than the “deactivated” period, in accordance with an embodiment of the disclosure)
Instruction/command generating-based processing (e.g., in association with generating the output signal(s), in accordance with an embodiment of the disclosure)

Moreover, as mentioned earlier, it is appreciable that the UE (e.g., an apparatus 102) can be configured to perform at least one processing task in association with adaptive control-based processing based on the input signal(s) in a manner so as to generate one or more output signals. Adaptive control-based processing can be associated with adapting UE behavior based on status(es)/mode(s) associated with the gNB. UE behavior can, for example, include/be associated with/based on one or both of:
the aforementioned skipping of at least one active period (e.g., as discussed with reference to the first example scenario, in accordance with an embodiment of the disclosure).
the aforementioned extending/increasing of at least one active period (e.g., as discussed with reference to the first example scenario, in accordance with an embodiment of the disclosure)

In this regard, it is appreciable that the UE can be configured to perform at least one processing task in association with adaptive control-based processing based on any one of receiving-based processing, determination-based processing, comparison-based processing and instruction/command generating-based processing, or any combination thereof (i.e., receiving-based processing, determination-based processing, comparison-based processing and/or instruction/command generating-based processing).

Specifically, UE behavior (e.g., referable to as apparatus 102 operational configuration(s)/mode(s)) can, for example, include/be associated with/based on skipping of at least one active period and/or extension/increase of at least one active period, in accordance with an embodiment of the disclosure.

Moreover, in the above manner, it is appreciable that UE behavior can be regulated/tweaked by manner of one or both of:
skipping at least one active period as appropriate (e.g., as discussed with reference to the first example scenario, in accordance with an embodiment of the disclosure)
extending at least one active period based on cell activation and/or deactivation period as appropriate (e.g., as discussed with reference to the second example scenario, in accordance with an embodiment of the disclosure)
   so as to facilitate efficiency (e.g., power/energy efficiency and/or communication efficiency), in accordance with an embodiment of the disclosure. For example, unnecessary consumption of power can desirably be reduced (or, preferably, eliminated) and/or unnecessary data access delay can desirably be reduced (or, preferably, eliminated), in accordance with an embodiment of the disclosure.

The above-described advantageous aspect(s) of the system 100 of the present disclosure can also apply analogously (all) the aspect(s) of a below described apparatus 102 of the present disclosure. Likewise, all below described advantageous aspect(s) of the apparatus 102 of the disclosure can also apply analogously (all) the aspect(s) of above described system 100 of the disclosure.

The aforementioned apparatus(es) 102 will be discussed in further detail with reference to FIG. 2 hereinafter.

Referring to FIG. 2, an apparatus 102 is shown in further detail in the context of an example implementation 200, according to an embodiment of the disclosure.

In the example implementation 200, the apparatus 102 can correspond to an electronic module 200a. The electronic module 200a can, in one example, correspond to a mobile device which can, for example, be carried into the vehicle by a user, in accordance with an embodiment of the disclosure. In another example, the electronic module 200a can correspond to an electronic device which can be installed/mounted in the vehicle, in accordance with an embodiment of the disclosure. In this regard, the electronic module 200a can be considered to be carried by the vehicle (e.g., either carried into the vehicle by a user or installed/mounted in the vehicle).

It is contemplated that the electronic module 200a can be capable of performing one or more processing tasks in association with adaptive control-based processing, in accordance with an embodiment of the disclosure. Adaptive control-based processing can, for example, be in association with adaptively controlling (e.g., regulating/tweaking as discussed earlier in the context of the example implementation of FIG. 1, in accordance with an embodiment of the disclosure) operational configuration (e.g., UE behavior as discussed earlier, in accordance with an embodiment of the disclosure with reference to the example implementation of FIG. 1) of the electronic module 200a, in accordance with an embodiment of the disclosure.

Generally, operational configuration of the electronic module 200a can, for example, be controlled based on status(es)/mode(s) associated with at least one device 104 (e.g., at least one gNB), in accordance with an embodiment of the disclosure. In this regard, one or more input signals which can be indicative of status(es)/mode(s) associated with the device(s) 104 can be communicated to the electronic module 200a which can perform at least one processing task associated with adaptive control-based processing based on received the input signal(s), in accordance with an embodiment of the disclosure, as will be discussed in further detail hereinafter.

Further generally, the electronic module 200a can be configured to perform at least one processing task which can include any one of, or any combination of, the following:
Receiving-based processing (e.g., in association with receiving the input signal(s), in accordance with an embodiment of the disclosure)
Determination-based processing (e.g., in association with determining whether the “deactivated” status/mode period associated with the gNB coincides with the “DRX active time” period, as discussed in the context of an example implementation in FIG. 1, in accordance with an embodiment of the disclosure.
Comparison-based processing (e.g., in association with comparing whether the “DRX active time” period is longer/shorter than the “deactivated” period, as discussed on the context of an example implementation in FIG. 1, in accordance with an embodiment of the disclosure)
Instruction/command generating-based processing (e.g., in association with generating the output signal(s), in accordance with an embodiment of the disclosure).

Moreover, adaptive control-based processing can, for example, include/be associated with/based on any one of receiving-based processing, determination-based processing, comparison-based processing and instruction/command generating-based processing, or any combination thereof (i.e., receiving-based processing, determination-based processing, comparison-based processing and/or instruction/command generating-based processing), in accordance with an embodiment of the disclosure.

In one embodiment, adaptive control-based processing can, for example, include/be associated with/based on one or both of determination-based processing and comparison-based processing (determination-based processing and/or comparison-based processing). In another embodiment, adaptive control-based processing can, for example, be based on/be associated with/include determination-based processing and comparison-based processing. In yet another embodiment, adaptive control-based processing can, for example, be based on/be associated with/include any one of determination-based processing, comparison-based processing and instruction/command generating based processing, or any combination thereof (i.e., determination-based processing, comparison-based processing and/or instruction/command generating based processing). In yet another additional embodiment, adaptive control-based processing can, for example, be based on/include/be associated with determination-based processing, comparison-based processing and instruction/command generating based processing. In yet another further additional embodiment, adaptive control-based processing can, for example, be based on/include/be associated with receiving-based processing, determination-based processing, comparison-based processing and instruction/command generating based processing.

The electronic module 200a can, for example, include a casing 200b. Moreover, the electronic module 200a can, for example, carry any one of a first module 202, a second module 204, a third module 206, or any combination thereof.

In one embodiment, the electronic module 200a can carry a first module 202, a second module 204 and/or a third module 206. In a specific example, the electronic module 200a can carry a first module 202, a second module 204 and a third module 206, in accordance with an embodiment of the disclosure.

In this regard, it is appreciable that, in one embodiment, the casing 200b can be shaped and dimensioned to carry any one of the first module 202, the second module 204 and the third module 206, or any combination thereof.

The first module 202 can be coupled to one or both of the second module 204 and the third module 206. The second module 204 can be coupled to one or both of the first module 202 and the third module 206. The third module 206 can be coupled to one or both of the first module 202 and the second module 204. In one example, the first module 202 can be coupled to the second module 204 and the second module 204 can be coupled to the third module 206, in accordance with an embodiment of the disclosure. Coupling between the first module 202, the second module 204 and/or the third module 206 can, for example, be by manner of one or both of wired coupling and wireless coupling. Each of the first module 202, the second module 204 and the third module 206 can correspond to one or both of a hardware-based module and a software-based module, according to an embodiment of the disclosure.

In one example, the first module 202 can correspond to a hardware-based receiver which can be configured to receive one or more input signals. The input signal(s) can, for example, be communicated from the device(s) 104 (e.g., a UE), in accordance with an embodiment of the disclosure.

The second module 204 can, for example, correspond to a hardware-based processor which can be configured to perform one or more processing tasks (e.g., in a manner so as to generate one or more output signals) in association with any one of, or any combination of, the following:
Receiving-based processing
Determination-based processing
Comparison-based processing
Instruction/command generating-based processing

Moreover, the second module 204 can be configured to perform at least one processing task in association with adaptive control-based processing which, as discussed earlier, can be based on/be associated with/include any one of receiving-based processing, determination-based processing, comparison-based processing and instruction/command generating-based processing, or any combination thereof (i.e., receiving-based processing, determination-based processing, comparison-based processing and/or instruction/command generating-based processing), in accordance with an embodiment of the disclosure.

The third module 206 can correspond to a hardware-based transmitter which can be configured to communicate one or more output signals from the electronic module 200a. The output signal(s) can, for example, include/correspond to one or more instructions/commands in association with adaptively controlling (e.g., regulating/tweaking as discussed earlier in the context of the example implementation of FIG. 1, in accordance with an embodiment of the disclosure) operational configuration of the electronic module 200a, in accordance with an embodiment of the disclosure.

Adaptive control of the operational configuration of the electronic module 200a can be based on status(es)/mode(s) associated with at least one device 104 and can be associated with/based on/include one or both of:
skipping at least one active period as appropriate (e.g., as discussed with reference to the first example scenario, in accordance with an embodiment of the disclosure)
extending/increasing at least one active period as appropriate (e.g., as discussed with reference to the second example scenario, in accordance with an embodiment of the disclosure)

In this regard, the operational configuration of the electronic module 200a can be adaptively controlled in accordance with status(es)/mode(s) associated with at least one device 104 by manner of skipping at least one active period as appropriate and/or extending at least one active period as appropriate, in accordance with an embodiment of the disclosure.

In one example, if the electronic module 200a was supposed to have been operating in “active/wake-up” period/mode (e.g., “DRX active time”), the electronic module 200a can be adaptively controlled to operate in “sleep” mode instead, based on the device 104 status/mode (e.g., in an event where “DRX active time” period coincides with the “deactivated” period associated with the device 104 and the “DRX active time” period is shorter than the “deactivated” period). In this regard, the electronic module 200a can be considered to be adaptively controlled to go into “sleep” mode when the electronic module 200a would have supposed to have been operating in “active/wake-up” period/mode instead (i.e., the operational configuration associated with the electronic module 200a can be considered to be adaptively controlled in a manner so as to skip the electronic module 200a “active”/“Wake-up” period), in accordance with an embodiment of the disclosure.

In another example, if the electronic module 200a is operating in “active/wake-up” period/mode (e.g., “DRX active time”), the electronic module 200a can be adaptively controlled to operate in extended “active/wake-up” period (time-based extension/increase in “active/wake-up” period with respect to the current “active/wake-up” period) based on the device 104 status/mode (e.g., in an event where the “DRX active time” period coincides with the “deactivated” period associated with the device 104, the electronic module 200a can be configured to extend/increase the “DRX active time” period if the “DRX active time” period is longer than the “deactivated” period). In this regard, the electronic module 200a can be considered to be adaptively controlled to increase/extend the electronic module 200a “active”/“Wake-up” period (which is determined to be longer than the coinciding device 104 “deactivated” period), in accordance with an embodiment of the disclosure. Specifically, operational configuration associated with the electronic module 200a can be adaptively controlled in a manner such that at least one “active/wake-up” period/mode (e.g., extension/increase of “active period”) can be extended/increased, in accordance with an embodiment of the disclosure.

Moreover, as an option, the output signal(s) can, for example, be communicated from the electronic module 200a to, for example, one or both of at least one device 104 (e.g., a UE) and another apparatus 102 (at least one other gNB), in accordance with an embodiment of the disclosure.

The present disclosure contemplates the possibility that the first and second modules 202/204 can be an integrated software-hardware based module (e.g., an electronic part which can carry a software program/algorithm in association with receiving and processing functions/an electronic module programmed to perform the functions of receiving and processing). The present disclosure further contemplates the possibility that the first and third modules 202/206 can be an integrated software-hardware based module (e.g., an electronic part which can carry a software program/algorithm in association with receiving and transmitting functions/an electronic module programmed to perform the functions of receiving and transmitting). The present disclosure yet further contemplates the possibility that the first and third modules 202/206 can be an integrated hardware module (e.g., a hardware-based transceiver) capable of performing the functions of receiving and transmitting.

In view of the foregoing, it is appreciable that the present disclosure generally contemplates an apparatus 102 which operational configuration (e.g., referable to as “apparatus behavior”) can, for example, be adaptively controlled (e.g., regulated/tweaked), in accordance with an embodiment of the disclosure. Moreover, the apparatus 102 (e.g., a UE) can, for example, be communicable with at least one device 104 (e.g., which can be associated with at least one gNB), in accordance with an embodiment of the disclosure.

The apparatus 102 can, for example, be configured to receive (e.g., to be capable of receiving) one or more input signals which can be indicative of at least one status associated with at least one device 102 (i.e., at least one device status), in accordance with an embodiment of the disclosure.

In one embodiment, the apparatus 102 can, for example, include a receiver 202 (e.g., the earlier discussed first module 202) and a processor 204 (e.g., the earlier discussed second module 204). The receiver 202 can, for example, be coupled to the processor 204.

The receiver 202 can, for example, be configured to receive the input signal(s), in accordance with an embodiment of the disclosure.

The processor 204 can, for example, be configured to perform at least one processing task in association with adaptive control-based processing in a manner so as to adaptively control operational configuration associated with the apparatus 102, in accordance with an embodiment of the disclosure. Operational configuration associated with the apparatus 102 can, for example, be adaptively controlled based on the input signal(s). Moreover, operational configuration associated with the apparatus 102 can, for example, be associated with at least one wake-up period (e.g., time-based period).

In one embodiment, operational configuration associated with the apparatus 102 can be capable of being adaptively controlled by manner of one or both of skipping at least one wake-up period (e.g., as discussed with reference to the first example scenario, in accordance with an embodiment of the disclosure) and extending at least one wake-up period (e.g., as discussed with reference to the second example scenario, in accordance with an embodiment of the disclosure). In this regard, it is appreciable that operational configuration associated with the apparatus 102 can be capable of being adaptively controlled by manner of skipping at least one wake-up period and/or extending at least one wake-up period (i.e., at least one of skipping at least one wake-up period and extending at least one wake-up period).

In one embodiment, the input signal(s) can be indicative of a device status (i.e., status associated with the device 104) being associated with at least one deactivated period. Moreover, operational configuration associated with the apparatus 102 can be capable of being adaptively controlled by manner of skipping at least one wake-up period when:
the least one wake-up period coincides with the deactivated period, and.
the at least one wake-up period is shorter than the deactivated period.

In one embodiment, the input signal(s) can be indicative of a device status (i.e., status associated with the device 104) being associated with at least one deactivated period. Moreover, operational configuration associated with the apparatus 102 can be capable of being adaptively controlled by manner of extending at least one wake-up period when:
the at least one wake-up period coincides with the deactivated period, and.
the at least one wake-up period is longer than the deactivated period.

Moreover, in one embodiment, adaptive control-based processing can, for example, be based on any one of, or any combination of, the following:
determination-based processing,
comparison-based processing, and
instruction generating-based processing.

Specifically, adaptive control-based processing can, for example, be based on determination-based processing, comparison-based processing and/or instruction generating-based processing (i.e., at least one of determination-based processing, comparison-based processing and instruction generating-based processing), in accordance with an embodiment of the disclosure.

In one embodiment, determination-based processing can, for example, be associated with determining whether the least one wake-up period coincides with the deactivated period.

Additionally, in one embodiment, comparison-based processing can, for example, be associated with comparing the at least one wake-up period and the deactivated period in a manner so as to determine whether the at least one wake-up period is shorter than the deactivated period. In another embodiment, the comparison-based processing can, for example, be associated with comparing the deactivated period and the at least one wake-up period in a manner so as to determine whether the at least one wake-up period is longer than the deactivated period.

Furthermore, in one embodiment, instruction generating-based processing can, for example, be associated with generating one or more output signals in association with adaptive control of the operational configuration by manner of skipping at least one wake-up period. In another embodiment, instruction generating-based processing can, for example, be associated with generating one or more output signals in association with adaptive control of the operational configuration by manner of extending at least one wake-up period.

The present disclosure contemplates that by manner of, for example, adaptive control (e.g., regulating/tweaking) by manner of one or both of skipping at least one active period as appropriate and/or extending at least one active period as appropriate, efficiency (e.g., power/energy efficiency and/or communication efficiency) can possibly be facilitated, in accordance with an embodiment of the disclosure. For example, unnecessary consumption of power can possibly be reduced (or, preferably, eliminated) and/or unnecessary data access delay can possibly be reduced (or, preferably, eliminated), in accordance with an embodiment of the disclosure.

The above-described advantageous aspect(s) of the apparatus 102 of the present disclosure can also apply analogously (all) the aspect(s) of a below described processing/communication method of the present disclosure. Likewise, all below described advantageous aspect(s) of the processing/communication method of the disclosure can also apply analogously (all) the aspect(s) of above described apparatus 102 of the disclosure. It is to be appreciated that these remarks apply analogously to the earlier discussed system 100 of the present disclosure.

Referring to FIG. 3, a communication method (also referable to as a processing method) in association with the system 100 is shown, according to an embodiment of the disclosure.

The processing method 300 can, for example, be suitable for/capable of facilitating energy efficiency and/or communication efficiency, in accordance with an embodiment of the disclosure.

The processing method 300 can include any one of an input step 302, a processing step 304 and an output step 306, or any combination thereof, in accordance with an embodiment of the disclosure.

In one embodiment, the processing method 300 can include the input step 302. In another embodiment, the processing method 300 can include the input step 302 and the processing step 304. In another embodiment, the processing method 300 can include the input step 302, the processing step 304 and the output step 306. In yet another embodiment, the processing method 300 can include the processing step 304 and one or both of the input step 302 and the output step 306. In yet a further embodiment, the processing method 300 can include the input step 302, the processing step 304 and the output step 306. In yet a further additional embodiment, the processing method 300 can include the processing step 304. In yet another further additional embodiment, the processing method 300 can include any one of or any combination of the input step 302, the processing step 304 and the output step 306 (i.e., the input step 302, the processing step 304 and/or the output step 306).

With regard to the input step 302, one or more input signal(s) can be received. For example, the input signal(s) (e.g., indicative of at least one status/mode which can be associated with at least one device 104) can be received by an apparatus 102, in accordance with an embodiment of the disclosure.

With regard to the processing step 304, at least processing task associated with adaptive control-based processing can be performed in a manner so as to generate one or more output signals which can include/correspond to/be associated with at least one instruction/at least one command for one or both of:
skipping at least one wake-up period
extending at least one wake-up period

With regard to the output step 306, the output signal(s) can, for example, be communicated as an option, in accordance with an embodiment of the disclosure. For example, the output signal(s) can optionally be communicated from the apparatus 102. In a more specific example, the output signal(s) can optionally be communicated from the apparatus 102 to one or both of at least one device 104 and another apparatus 102, in accordance with an embodiment of the disclosure.

In view of the foregoing, it is appreciable that the present disclosure generally contemplates a communication/processing method 300.

The processing method 300 can, for example, include an input step 302 and a processing step 304, in accordance with an embodiment of the disclosure.

The input step 302 can, for example, include receiving (e.g., by an apparatus 102 which can be associable with/correspond to a UE) one or more input signals which can be indicative of status associated with at least one device 104 (e.g., corresponding to/associable with a gNB), in accordance with an embodiment of the disclosure.

The processing step 304 can, for example, include performing at least one processing task (e.g., by an apparatus 102) which can be associated with/include at least one adaptive control-based processing, in accordance with an embodiment of the disclosure. The processing task(s) associated with adaptive control-based processing can, for example, be performed based on the input signal(s), in accordance with an embodiment of the disclosure. Moreover, the processing task(s) associated with adaptive control-based processing can, for example, be performed in a manner so as to adaptively control operational configuration (e.g., behavior) associated with at least one apparatus 102 based on status associated with the device(s) 104, in accordance with an embodiment of the disclosure.

In one embodiment, operational configuration associated with the apparatus 102 can, for example be associated with at least one of a wake-up period. Moreover, the input signal(s) can be indicative of device status (e.g., status(es)/mode(s) associated with the device(s) 104) being associated with, for example, at least one deactivated period. Furthermore, operational configuration associated with the apparatus 102 can be capable of being adaptively controlled by manner of, for example, skipping at least one wake-up period (e.g., as discussed with reference to the first example scenario, in accordance with an embodiment of the disclosure) when:
the least one wake-up period coincides with the deactivated period, and.
the at least one wake-up period is shorter than the deactivated period.

In one embodiment, operational configuration associated with the apparatus 102 can, for example be associated with at least one of a wake-up period. Moreover, the input signal(s) can be indicative of device status (e.g., status(es)/mode(s) associated with the device(s) 104) being associated with, for example, at least one deactivated period. Furthermore, operational configuration associated with the apparatus 102 can be capable of being adaptively controlled by manner of, for example, extending at least one wake-up period (e.g., as discussed with reference to the second example scenario, in accordance with an embodiment of the disclosure) when:
the least one wake-up period coincides with the deactivated period, and.
the at least one wake-up period is longer than the deactivated period.

The present disclosure contemplates that by manner of, for example, adaptive control (e.g., regulating/tweaking) by manner of one or both of skipping at least one active period as appropriate and/or extending at least one active period as appropriate, efficiency (e.g., power/energy efficiency and/or communication efficiency) can possibly be facilitated, in accordance with an embodiment of the disclosure. For example, unnecessary consumption of power can possibly be reduced (or, preferably, eliminated) and/or unnecessary data access delay can possibly be reduced (or, preferably, eliminated), in accordance with an embodiment of the disclosure.

The present disclosure further contemplates a computer program (not shown) which can include instructions which, when the program is executed by a computer (not shown), cause the computer to carry out the input step 302, the processing step 304 and/or the output step 306 as discussed with reference to the communication/processing method 300. For example, the computer program can include instructions which, when the program is executed by a computer, cause the computer to carry out the input step 302 and the processing step 304, in accordance with an embodiment of the disclosure.

The present disclosure yet further contemplates a computer readable storage medium (not shown) having data stored therein representing software executable by a computer (not shown), the software including instructions, when executed by the computer, to carry out the input step 302, the processing step 304 and/or the output step 306 as discussed with reference to the communication/processing method 300. For example, the computer readable storage medium can have data stored therein representing software executable by a computer, the software including instructions, when executed by the computer, cause the computer to carry out the input step 302 and the processing step 304, in accordance with an embodiment of the disclosure.

It should be appreciated that the embodiments described above can be combined in any manner as appropriate (e.g., one or more embodiments as discussed in the “Detailed Description” section can be combined with one or more embodiments as described in the “Summary of the Invention” section).

It should be further appreciated by the person skilled in the art that variations and combinations of embodiments described above, not being alternatives or substitutes, may be combined to form yet further embodiments.

In one example, the possibility of the output signal(s) being communicated from the apparatus(es) 102 was discussed. It is appreciable that the output signal(s) need not necessarily be communicated from the apparatus(es) 102. Specifically, the possibility that the output signal(s) need not necessarily be communicated outside of the apparatus(es) 102 is contemplated, in accordance with an embodiment of the disclosure. More specifically, the output signal(s) can, for example, correspond to internal command(s)/instruction(s) (e.g., communicated only within an apparatus 102) for adaptively controlling operational configuration of an apparatus 102, in accordance with an embodiment of the disclosure.

In another example, it can be appreciated that the present disclosure can, for example, be generally in relation to 3GPP Network Energy Saving standard. For example, it is contemplated that enhanced energy saving can generally be facilitated for radio access type device(s), in accordance with embodiment(s) of the disclosure. In this regard, while downlink (DL) type communication (e.g., DL data transmission) was discussed, it is appreciable other possibilities such as uplink-based communication can be applicable, as appropriate.

In yet another example, the foregoing discussion need not necessarily be limited/be based only on a vehicular-based context/application(s). One or more other example applications can also be useful. An example application can be based on a general mobile phone communication type application (e.g., general Smart-phone usage) which can be unrelated to vehicular-based context/application(s).

In yet another further example, as discussed earlier, the electronic module 200a can be adaptively controlled to operate in extended “active/wake-up” period in an event where, for example, the “DRX active time” period coincides with the “deactivated” period associated with the device 104 and the “DRX active time” period is longer than the “deactivated” period. It is appreciable that one or more other bases for increasing/extending the wake-up period can also be helpful. For example, increase/extension of the wake-up period can be on the basis of the possibility that the original/current wake-up period is shorter than the current activated period and it could be helpful to increase/extend the current wake-up period to match the current activated period. In this regard, it is appreciable that increase/extension of the wake-up period can, for example, be based on an activated period, in accordance with an embodiment of the disclosure.

In yet another further additional example, earlier contemplated, a UE can possibly be configured to extend/increase a wake-up period based on MAC CE by manner of communicating, from a gNB, at least one MAC CE signal before a current wake up period is set to expire. The present disclosure contemplates that one or more other examples can be possible. In one other example, a UE can be configured to extend a wake up period based on Physical Downlink Control Channel (PDCCH) by manner of communicating (e.g., by a gNB) at least one PDCCH signal before a wake up period is set to expire and the PDCCH signal(s) can be capable of indicating desired/required extension (e.g., time period for UE to extend wake up period). In another other example, a UE can be configured to extend wake up period based on time period indicated in RRC (Radio Resource Control). In yet another other example, a UE can be configured to extend wake up period based by manner of restarting wake up time.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1. An apparatus capable of receiving at least one input signal indicative of at least one device status, the apparatus comprising:
a receiver configured to receive the at least one input signal and a processor coupled to the receiver, the processor being configured to perform at least one processing task in association with adaptive control-based processing in a manner so as to adaptively control operational configuration associated with the apparatus based on the at least one input signal,
wherein operational configuration associated with the apparatus being associable with at least one wake-up period, and
wherein operational configuration associated with the apparatus capable of being adaptively controlled by manner of at least one of:
skipping at least one wake-up period, and
extending at least one wake-up period.

2. The apparatus according to claim 1, the at least one input signal being indicative of the at least one device status being associable with at least one deactivated period,
wherein operational configuration associated with the apparatus capable of being adaptively controlled by manner of skipping at least one wake-up period when the least one wake-up period coincides with the deactivated period, and the at least one wake-up period is shorter than the deactivated period.

3. The apparatus according to claim 1, wherein the at least one input signal being indicative of the at least one device status being associable with at least one deactivated period,
wherein operational configuration associated with the apparatus capable of being adaptively controlled by manner of extending at least one wake-up period when the at least one wake-up period coincides with the deactivated period, and the at least one wake-up period is longer than the deactivated period.

4. The apparatus according to claim 2, wherein the adaptive control-based processing being based on at least one of:
determination-based processing,
comparison-based processing, and
instruction generating-based processing.

5. The apparatus according to claim 4, wherein the determination-based processing is associable with determining whether the least one wake-up period coincides with the deactivated period.

6. The apparatus according to claim 4, wherein the comparison-based processing is associable with comparing the at least one wake-up period and the deactivated period in a manner so as to determine whether the at least one wake-up period is shorter than the deactivated period.

7. The apparatus according to claim 4, wherein the instruction generating-based processing is associable with generating at least one output signal in association with adaptive control of the operational configuration by manner of skipping at least one wake-up period.

8. The apparatus according to claim 4, wherein the comparison-based processing is associable with comparing the deactivated period and the at least one wake-up period in a manner so as to determine whether the at least one wake-up period is longer than the deactivated period.

9. The apparatus according to claim 4, wherein the instruction generating-based processing is associable with generating at least one output signal in association with adaptive control of the operational configuration by manner of extending at least one wake-up period.

10. A processing method comprising:
an input step comprising receiving, by an apparatus, at least one input signal indicative of status associated with at least one device;
a processing step comprising performing at least one processing task, by the apparatus, in association with at least one adaptive control-based processing based on the at least one input signal in a manner so as to adaptively control operational configuration associated with at least one apparatus based on status associated with the at least one device);
wherein the apparatus comprises:
a receiver configured to receive the at least one input signal and
a processor coupled to the receiver, the processor being configured to perform at least one processing task in association with adaptive control-based processing in a manner so as to adaptively control operational configuration associated with the apparatus based on the at least one input signal
wherein operational configuration associated with the apparatus being associable with at least one wake-up period, and
wherein operational configuration associated with the apparatus capable of being adaptively controlled by manner of at least one of:
skipping at least one wake-up period, and
extending at least one wake-up period.

11. The processing method according to claim 10, operational configuration associated with the apparatus being associable with at least one of a wake-up period and the at least one input signal being indicative of the at least one device status being associable with at least one deactivated period, wherein operational configuration associated with the apparatus capable of being adaptively controlled by manner of skipping at least one wake-up period when the least one wake-up period coincides with the deactivated period, and the at least one wake-up period is shorter than the deactivated period.

12. The processing method according to claim 10, operational configuration associated with the apparatus being associable with at least one of a wake-up period and the at least one input signal being indicative of the at least one device status being associable with at least one deactivated period, wherein operational configuration associated with the apparatus capable of being adaptively controlled by manner of extending at least one wake-up period when the least one wake-up period coincides with the deactivated period, and the at least one wake-up period is longer than the deactivated period.

13. (canceled)

14. A non-transitory computer readable storage medium having data stored therein representing software executable by a computer, the software including instructions that, when executed by the computer, carry out at least one of an input step and a processing step, wherein
the input step comprising receiving by an apparatus, at least one input signal indicative of status associated with at least one device;
the processing step comprising performing at least one processing task, by the apparatus, in association with at least one adaptive control-based processing based on the at least one input signal in a manner so as to adaptively control operational configuration associated with at least one apparatus based on status associated with the at least one device;
wherein the apparatus comprises:
a receiver configured to receive the at least one input signal and
a processor coupled to the receiver the processor being configured to perform at least one processing task in association with adaptive control-based processing in a manner so as to adaptively control operational configuration associated with the apparatus based on the at least one input signal
wherein operational configuration associated with the apparatus being associable with at least one wake-up period, and
wherein operational configuration associated with the apparatus capable of being adaptively controlled by manner of at least one of:
skipping at least one wake-up period, and
extending at least one wake-up period.
